(19) United States
(12) Patent Application Publication
(10) Pub. No.: US 2006/0086308 A1
(43) Pub. Date: Apr. 27, 2006

(54) Flagpole

(76) Inventor: Wu Tsung Chen, Tainan (TW)

Correspondence Address: Keith Kline;PRO-TECHTOR INTERNATIONAL SERVICES, 20775 Norada Court, Saratoga, CA, 95070-3018, US

(21) Appl. No.: 11/015,879

(22) Filed: Dec. 16, 2004

(30) Foreign Application Priority Data
Oct. 27, 2004 (TW) 93217051

(51) Int. Cl. G09F 17/00

(52) U.S. Cl. 116/174

(57) ABSTRACT

A flagpole is disclosed to include a pole, a cap rotatably capped on the top end of the pole to secure the top end of the inner side edge of a flag, a barrel rotatably sleeved onto the pole and spaced below the cap to secure the bottom end of the inner side edge of the flag held by the cap, and a link connected between the cap and the barrel for enabling the cap and the barrel to be synchronously turned about the pole to prevent winding of the flag round the pole when the flag is flying in the air.

### BACKGROUND OF THE INVENTION

1. Field of the Invention

The present invention relates to a flagpole for holding a flag and more particularly, to such a flagpole, which prevents winding of the flag round the pole when flying in the air.

2. Description of the Related Art

A flagpole is adapted to hold a flag, enabling the flag to fly on it. Conventionally, tie ropes or wires are used to fasten the top and bottom end of the inner side edge of the flag to the pole. However, when the flag is flying in the air on the pole, it may be forced to wind round the pole. FIG. 1 shows a flagpole according to the prior art. According to this design, the flagpole comprises a pole 20, and two swivel connectors (connecting buttons) 10 rotatably mounted on the pole 20 at different elevations near the top. The swivel connectors 10 each have an eyelet (circular portion) 101 for securing the top and bottom portions of the inner side edge of the flag 30. According to this design, the two swivel connectors 10 can be separately and freely turned about the pole 20. Because the upper and lower parts of the flag 30 may receive different amount of wind pressure when the flag 30 is flying in the air on the pole 20, the swivel connectors 10 may be respectively turned about the pole 20 at different speeds. In this case, the flag 30 will be forced to wind round the pole.

### SUMMARY OF THE INVENTION

The present invention has been accomplished under the circumstances in view. It is the main object of the present invention to provide a flagpole, which prevents winding of the flag round the pole. To achieve this and other objects of the present invention, the flagpole comprises a pole, a cap rotatably capped on the top end of the pole to secure the top end of the inner side edge of a flag, a barrel rotatably sleeved onto the pole and spaced below the cap to secure the bottom end of the inner side edge of the flag held by the cap, and a link connected between the cap and the barrel for enabling the cap and the barrel to be synchronously turned about the pole to prevent winding of the flag round the pole when the flag is flying in the air.

### BRIEF DESCRIPTION OF THE DRAWINGS

FIG. 1 is a schematic drawing showing a flag wound round a pole according to the prior art.

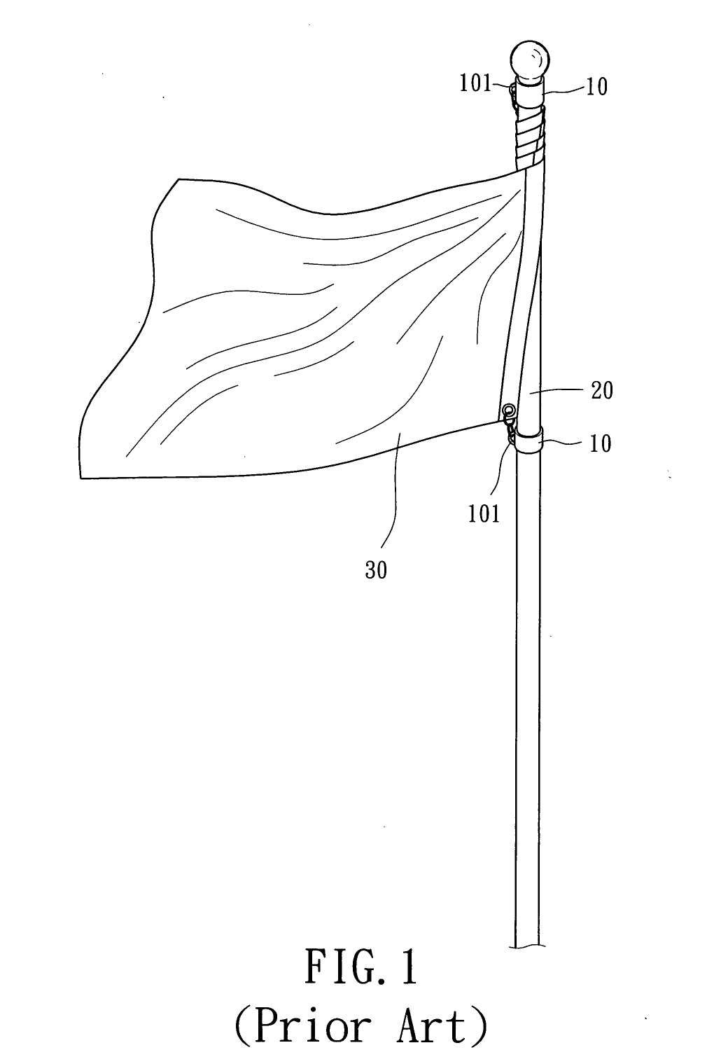

FIG. 2 is an elevational view showing a flag installed in a flagpole according to the present invention.

FIG. 3 is an exploded view in an enlarged scale of the assembly of FIG. 2 (the finial excluded).

FIG. 4 is an enlarged view of a part of FIG. 3.

FIG. 5 is an enlarged view, partially in section, of a part of FIG. 2.

FIG. 6 is a schematic top view of an alternate form of the present invention, showing three links connected in parallel to the cap and the barrel.

FIG. 7 is a schematic drawing of another alternate form of the present invention, showing the eyelets of the cap and barrel opened.

FIG. 8 is a schematic drawing of still another alternate form of the present invention.

### DETAILED DESCRIPTION OF THE PREFERRED EMBODIMENT

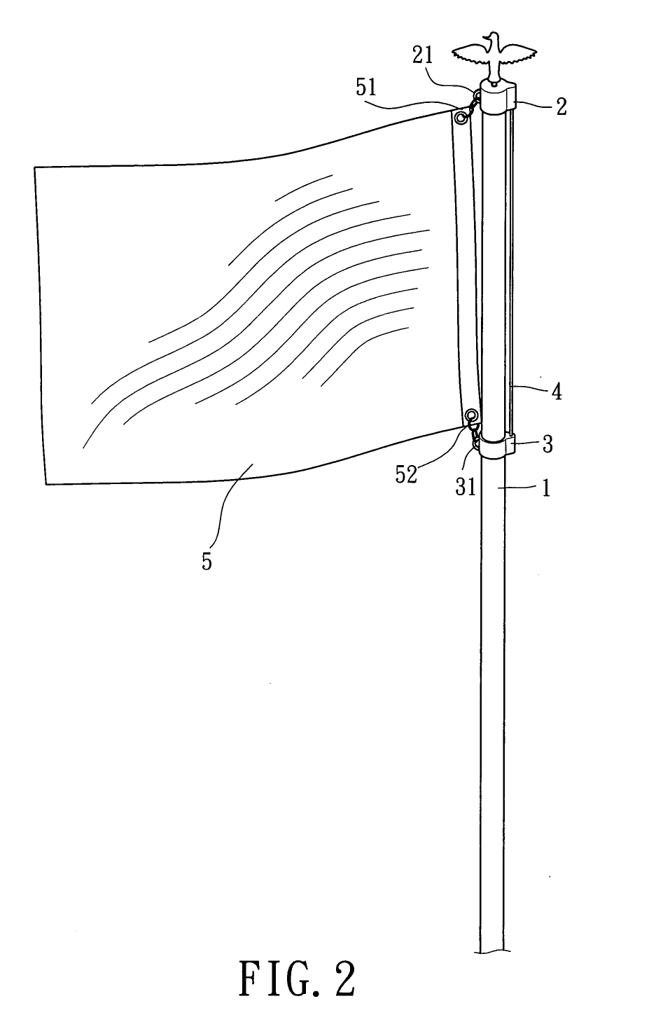

Referring to FIG. 2, a flagpole in accordance with the present invention is shown comprising a pole 1, a cap 2, a barrel 3, and a link 4.

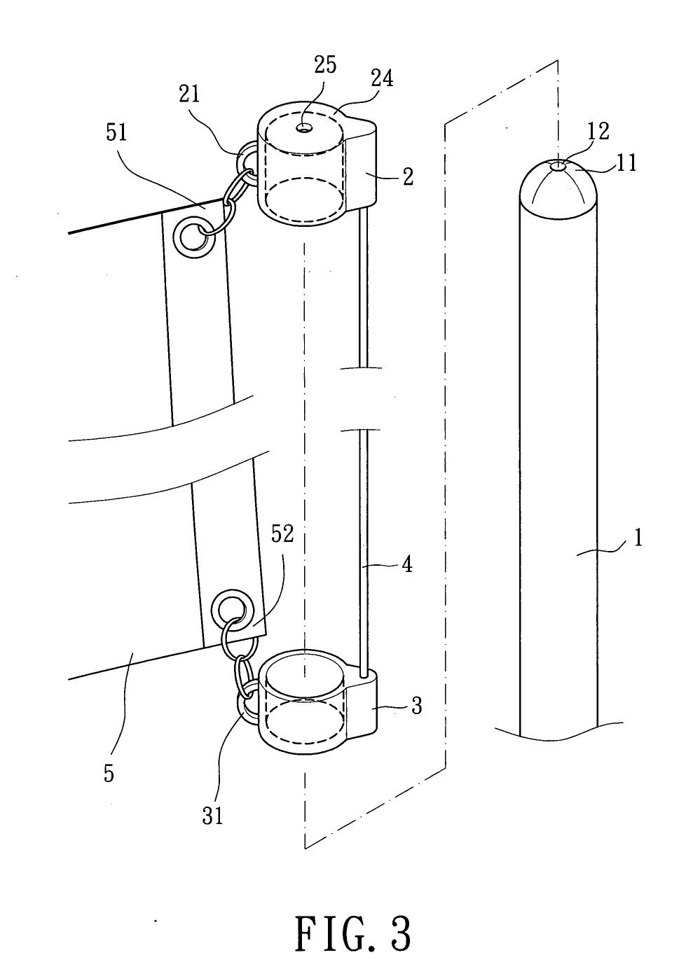

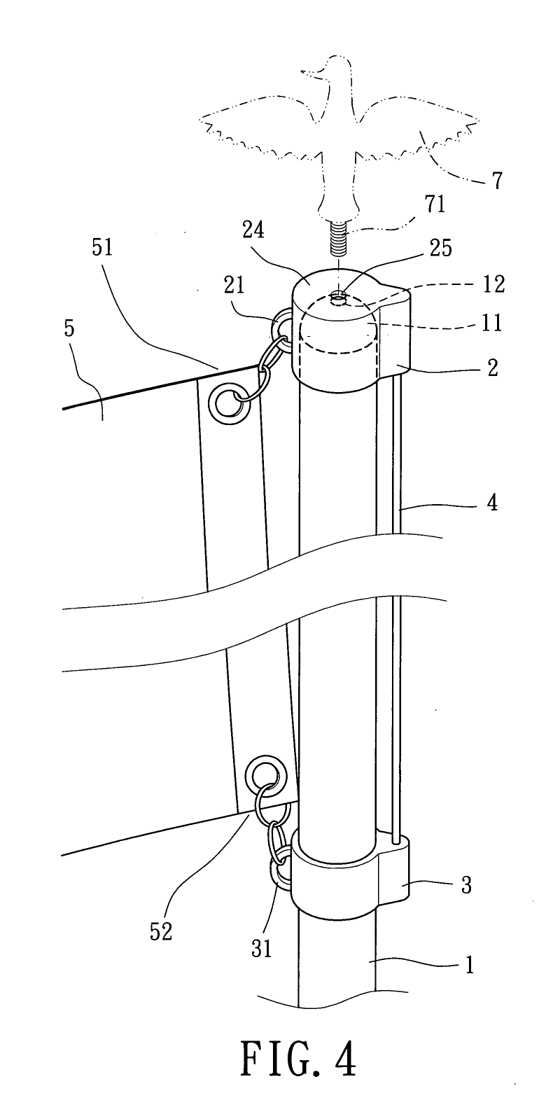

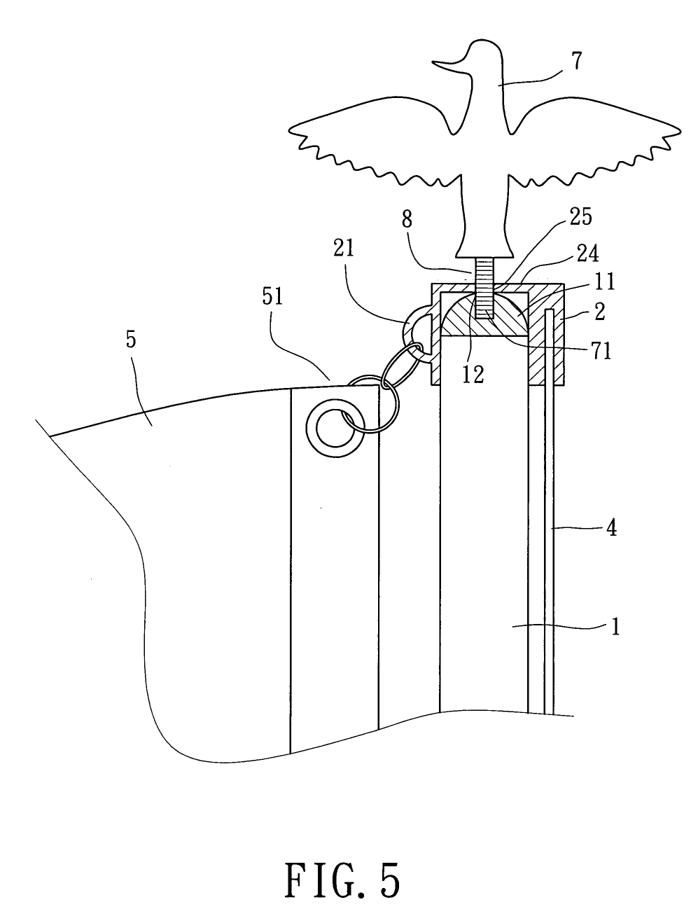

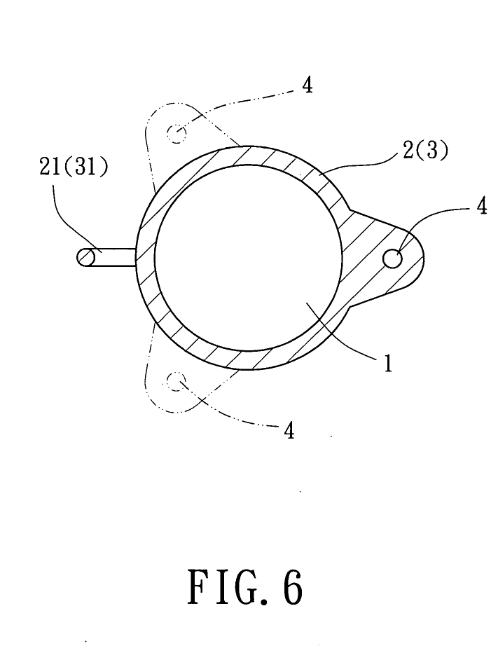

Referring to FIGS. 3˜5 and FIG. 2 again, the pole 1 is adapted to hold a flag 5. The cap 2 is rotatably capped on the top end 11 of the pole 1. The barrel 3 rotatably sleeved onto the pole 1. The cap 2 and the barrel 3 each have an eyelet 21 or 31 for the fastening of the inner top end 51 and inner bottom end 52 of the flag 5 (see FIGS. 4 and 5). The link 4 is a rod member connected between the cap 2 and the barrel 3 for allowing the cap 2 and the barrel 3 to be synchronously turned about the pole 1. The number of the link 4 is not limited to 1. For example, 3 links 4 may be connected used and connected in parallel between the cap 2 and the barrel 3 (see FIG. 6).

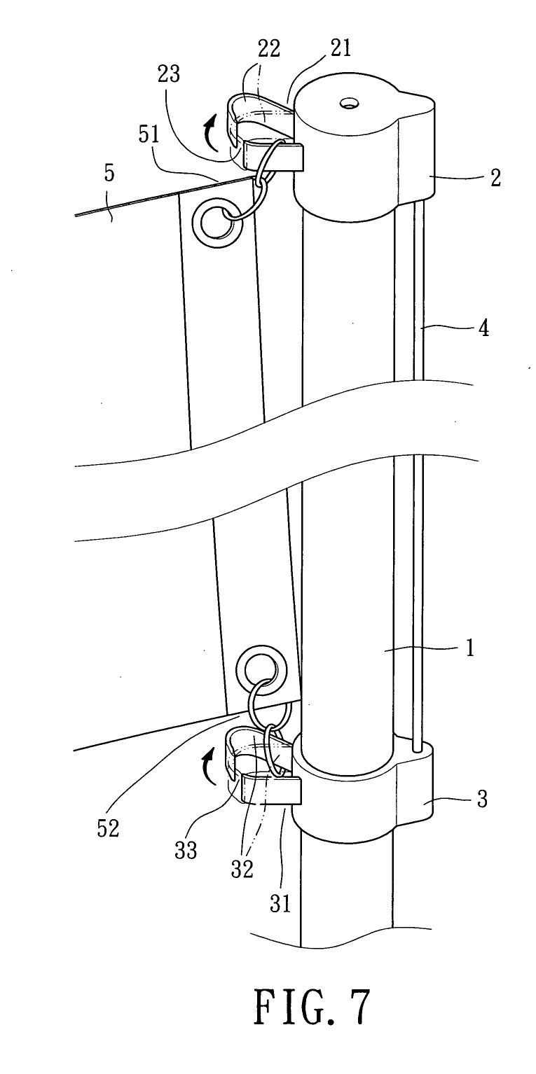

Referring to FIG. 7, the eyelet 21 or 31 may be formed of two smoothly arched, spring strips 22 or 32 respectively extending from the periphery thereof and defining therebetween a gate 23 or 33. The user can bend the spring strips 22 or 32 inwards/outwards to close/open the gate 23 or 33.

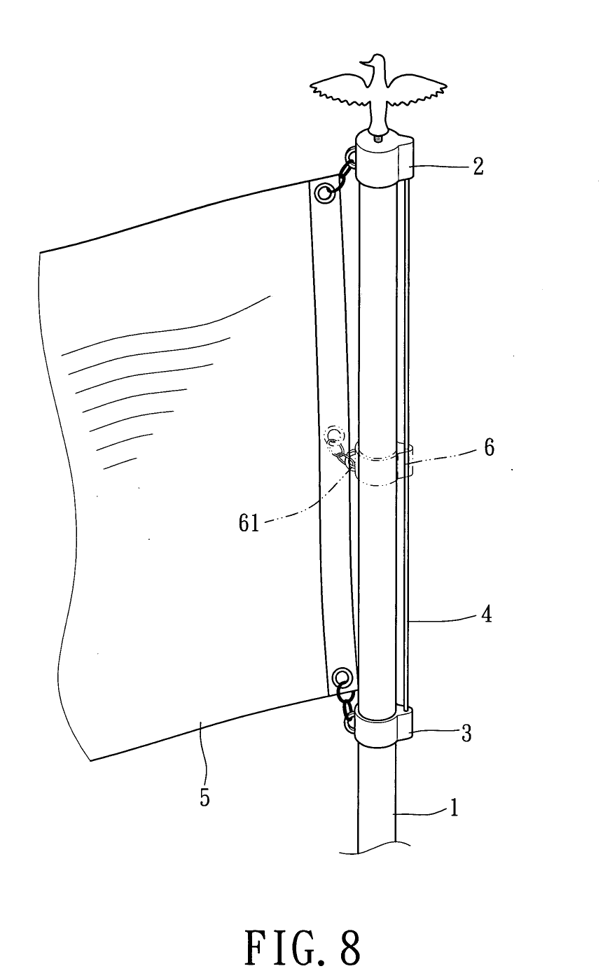

Referring to FIG. 8, a second barrel 6 may be sleeved onto the pole 1 and coupled to the link 4 between the cap 2 and the barrel 3. The second barrel 6 has an eyelet 61 for securing the middle part of the inner side of the flag 5.

Referring to FIGS. 3˜5 again, the top end 11 of the pole 1 smoothly curves outwards, having a screw hole 12 at the center. The cap 2 has a through hole 25 through the center of the top wall 24 thereof corresponding to the top screw hole 12 of the pole 1 for the mounting of a finial 7. The finial 7 has a bottom screw rod 71 inserted through the through hole 25 of the cap 2 and threaded into the center screw hole 12 of the pole 1. After installation of the finial 7 in the pole 7, a gap 8 is left between the top wall 24 of the cap 2 and the finial 7 so that the finial 7 does not interfere with free rotation of the cap 2 on the pole 1.

As indicated above, the cap 2 and the barrel 3 or barrels 3 and 6 are rotatably mounted on the pole 1 and connected together by the link 4, the cap 2 and the barrel 3 or barrels 3 and 6 will be synchronously turned about the pole 11 when the flag 5 receives a strong wind force, and therefore the flag 5 will not be wound round the pole 1 when flying in the air.

A prototype of flagpole has been constructed with the features of FIGS. 2˜8. The flagpole functions smoothly to provide all of the features discussed earlier.

Although particular embodiments of the invention have been described in detail for purposes of illustration, various modifications and enhancements may be made without departing from the spirit and scope of the invention.

1. A flagpole comprising:
a pole, said pole being unitary, and having a convex top end;
a hollow cylindrical cap, having a vertically oriented axis, a closed top and an open bottom, rotatably disposed over said top end of said pole for securing the top end of the inner side edge of a flag;
a barrel rotatably sleeved onto said pole and spaced below said cap for securing the bottom end of the inner side edge of the flag, the flag being held at the top end thereof by said cap; and
a link connected between said cap and said barrel;
wherein said cap and said barrel are enabled to be synchronously turned about said pole.

2. The flagpole as claimed in claim 1, wherein said link is a rod member having a top end connected to said cap and a bottom end connected to said barrel.

3. The flagpole as claimed in claim 1, wherein said cap and said barrel each have an eyelet for the fastening of the flag.

4. The flagpole as claimed in claim 3, wherein said eyelet is comprised of two smoothly arched, spring strips, said spring strips defining therebetween a gate that is openable by the user with the hands.

5. The flagpole as claimed in claim 1, further comprising at least one auxiliary barrels rotatably sleeved onto said pole and coupled to said link between said cap and said barrel for securing a part of the inner side edge of the flag.

6. The flagpole as claimed in claim 5, wherein each said auxiliary barrel has an eyelet for securing a part of the flag.

7. The flagpole as claimed in claim 1, wherein said top end of said pole has a hemispherical shape.

8. The flagpole as claimed in claim 1, wherein said pole has a screw hole in the top end; said cap has a through hole through a top wall thereof in axial alignment with said screw hole of said pole for the mounting of a finial.
